(19) United States
(12) Patent Application Publication
(10) Pub. No.: US 2026/0241532 A1
(43) Pub. Date: Aug. 20, 2026

(54) HANDHELD POWER TOOL

(71) Applicant: JIANGSU DONGCHENG TOOLS TECHNOLOGY CO., LTD., NANTONG, JIANGSU (CN)

(72) Inventors: AIGUO LIU, NANTONG, JIANGSU (CN); SIHAO YANG, NANTONG, JIANGSU (CN)

(21) Appl. No.: 18/870,378

(22) PCT Filed: Apr. 11, 2024
(86) PCT No.: PCT/CN2024/087313

§ 371 Date: Nov. 27, 2024

(30) Foreign Application Priority Data
May 30, 2023 (CN) 202310626115.0

(51) Int. Cl. B25F 5/00; B25F 5/02

(52) U.S. Cl. CPC B25F 5/001; B25F 5/02

(57) ABSTRACT

The present application relates to a handheld power tool, including a housing, a motor assembly and a transmission assembly, a switch assembly and a shift assembly. The switch assembly includes a switch component arranged at the housing and a trigger for triggering the switch component. The shift assembly includes a shift component connected to the transmission assembly and a button for moving the shift component. The trigger includes a base and a limiting portion arranged at the base, and the shift assembly includes a stop portion corresponding to the limiting portion. The limiting portion abuts against the stop portion, restricting the trigger from being pressed to a maximum extent. The button moves along a direction of a second axis approximately perpendicular to the first axis of the motor assembly, and is arranged between the transmission assembly and the switch assembly.

### CROSS-REFERENCE TO RELATED APPLICATIONS

The present disclosure is a 35 U.S.C. § 371 National Phase conversion of International (PCT) Patent Application No. PCT/CN2024/087313 filed on Apr. 11, 2024, which claims priority of Chinese Patent Application No. 202310626115.0, filed on May 30, 2023, the entire contents of which are hereby incorporated by reference in their entirety.

### TECHNICAL FIELD

The present disclosure relates to the field of power tools, and in particular, to a handheld power tool used in decoration, construction, and other occasions.

### BACKGROUND

A power tool is a type of instrument in which a working head is driven by a motor assembly to perform reciprocating motion. In order to convert a high-speed and low-torque force of the motor assembly into a low-speed and high-torque force required by a user, a planetary gear reducer is usually installed between the motor assembly and the working head. With continuous increase in user demand, handheld power tools on markets, especially those involving electric drills, will also be equipped with variable speed devices on planetary gear reduction devices. The user can adjust output speeds of the electric drill according to actual usage needs. A transmission device of a typical electric drill is equipped with a high-speed gear and a low-speed gear, and is manually switched through a gear shifting mechanism.

In addition, for the power tools using the planetary gear reducers, due to a theoretical model of planetary gears, a reduction ratio of each stage is 1+Z3/Z1, where Z3 is the number of teeth of an inner ring gear, Z1 is the number of teeth of a sun gear, and the reduction ratio of each stage of planetary gears is not less than 3. When designing an electric drill with the ratio of high speed to low speed less than 3, traditional planetary gear reducers are basically unable to meet diverse operational needs of the users.

### SUMMARY

In one aspect, the present disclosure provides a handheld power tool including a housing, a motor assembly and a transmission assembly, a switch assembly connected to the motor assembly, and a shift assembly connected to the transmission assembly. The housing includes a body and a handle connected to the body. The motor assembly and the transmission assembly are both received in the body, and the motor assembly has a first axis extending along a front to back direction. The switch assembly is connected to the motor assembly and arranged at the handle. The switch assembly includes a switch component arranged at the housing and a trigger for triggering the switch component, and the trigger includes a base and a limiting portion arranged at the base. The shift assembly includes a shift component connected to the transmission assembly, a button for moving the shift component, and a stop portion corresponding to the limiting portion. The limiting portion abuts against the stop portion, restricting the trigger from being pressed to a maximum extent. The button moves along a direction of a second axis approximately perpendicular to the first axis. The button is arranged between the transmission assembly and the switch assembly.

In another aspect, the present disclosure provides a handheld power tool including a housing, a motor assembly and a transmission assembly, an output end, a switch assembly, and a shift assembly. The housing includes a body and a handle connected to the body. The handle and the body are arranged at an angle. The motor assembly and a transmission assembly are both received in the body. The motor assembly has a first axis extending along a front to back direction, and the transmission assembly is a planetary gear reduction mechanism. The output end is driven by the transmission assembly, and the output end is configured to work in a first state and a second state that operate at different speeds. The switch assembly is connected to the motor assembly and arranged at the handle. The shift assembly is connected to the transmission assembly, and the shift assembly includes a shift component connected to the transmission assembly, and a button for moving the shift component. The button moves along a direction of a second axis approximately perpendicular to the first axis and is configured to switch between the first state and the second state, a speed in the second state is higher than a speed in the first state, and a ratio of the speed in the second state to the speed in the first state is less than 3.

In another aspect, the present disclosure provides a handheld power tool including a housing, a motor assembly, a transmission assembly, a switch assembly connected to the motor assembly, a shift assembly connected to the transmission assembly. The housing includes a body and a handle connected to the body. The motor assembly and the transmission assembly are both received in the body. The switch assembly is arranged at the handle. The motor assembly has a first axis extending along a front to back direction. The shift assembly includes a shift component connected to the transmission assembly and a button for moving the shift component. The button moves along a direction of a second axis approximately perpendicular to the first axis, and the button is arranged between the transmission assembly and the switch assembly.

### BRIEF DESCRIPTION OF THE DRAWINGS

The present disclosure will be described more fully below with reference to the relevant drawings and embodiments.

FIG. 1 is a schematic view of a handheld power tool in a low-speed gear state according to some embodiments of the present disclosure.

FIG. 2 is a schematic view of a handheld power tool in a high-speed gear state according to some embodiments of the present disclosure.

FIG. 3 is a schematic structural view of a shift assembly arranged at two positions in the handheld power tool shown in FIG. 1.

FIG. 4 is a schematic structural view of the shift assembly shown in FIG. 3 from another view angle.

FIG. 5 is a schematic structural view of a shift assembly and a switch assembly in the handheld power tool shown in FIG. 1 from a first view angle.

FIG. 6 is a schematic structural view of the shift assembly and the switch assembly shown in FIG. 5 from a second view angle.

FIG. 7 is a schematic structural view of the shift assembly and the switch assembly shown in FIG. 5 from a third view angle.

FIG. 8 is a schematic view of connection between an intermediate plate and a guide in the shift assembly shown in FIG. 3.

FIG. 9 is a schematic view of connection between a button and a guide in the shift assembly shown in FIG. 3.

FIG. 10 is a schematic structural view of a stop portion and a trigger of the handheld power tool in the low-speed gear state shown in FIG. 1.

FIG. 11 is a schematic structural view of the structure of a stop portion and a trigger of the handheld power tool in the high-speed gear state shown in FIG. 2.

FIG. 12 is a schematic structural view of a trigger in the handheld power tool shown in FIG. 1.

FIG. 13 is a schematic structural view of the trigger shown in FIG. 12 from another view angle.

### DETAILED DESCRIPTION

The present disclosure will be described more fully below with reference to the relevant drawings and embodiments.

Terms used in the description of the present disclosure herein are only for the purpose of describing specific embodiments and are not intended to limit the present disclosure. For example, it should be understood that the orientations or locational relations that are indicated by terms such as “upper”, “lower”, “front”, “back”, “left”, “right” and the like are based on the orientations and locational relations illustrated in the drawings, which are only for the convenience of describing the present disclosure and simplifying the description, and do not indicate or imply that the device or component referred to must have a specific orientation or be configured and operate in a specific orientation, so these terms cannot be understood as limiting the present disclosure.

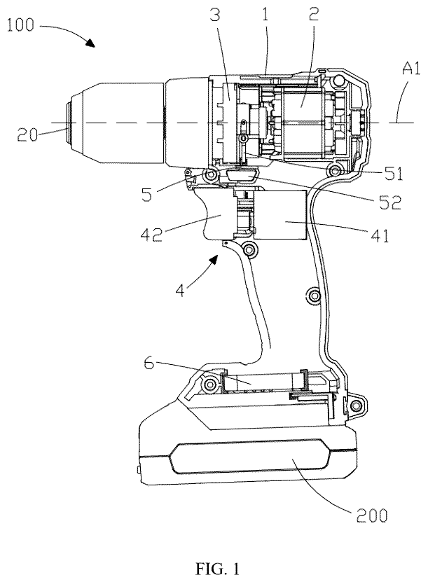

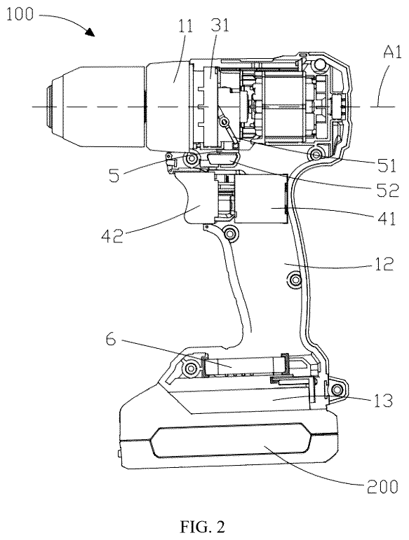

Please referring to FIG. 1 and FIG. 2, some embodiments of the present disclosure relate to a handheld power tool, which is an electric drill 100 powered by direct-current, DC, and is suitable for tightening or loosening screws and performing drilling operations on walls. The electric drill 100 includes a housing 1, a motor assembly 2 and a transmission assembly 3 both arranged at the housing 1, a switch assembly 4 connected to the motor assembly 2, a shift assembly 5 connected to the transmission assembly 3, an output end 20 driven by the transmission assembly 3, a control assembly 6 for controlling the motor assembly 2, and a battery pack 200 supplying energy to the motor assembly 2. The battery pack 200 is detachably arranged at the housing 1 for easy charging of the battery pack 200. Specifically, the above-mentioned switch assembly 4 is electrically connected to the control assembly 6. When a user presses the switch assembly 4, the motor assembly 2 is started to rotate at a high speed, and a force is transmitted to the output end 20 through the transmission assembly 3. A batch head is clamped on the output end 20 to operate a workpiece.

In the embodiments, the transmission assembly 3 is a planetary gear reduction mechanism, and is suitable for converting a high-speed and low-torque force output by the motor assembly 2 into a low-speed and high-torque force required by the user. In order to meet diverse needs of the user, the output end 20 is configured to work in a first state and a second state that operate at different speeds. Correspondingly, the planetary gear reduction mechanism has an inner ring gear 31 which has an ability of being moved. The first state is a low-speed gear state, in which the inner ring gear 31 participates in a deceleration process, and the output end 20 runs at a low speed. The second state is a high-speed gear state, in which the inner ring gear is disengaged and does not participate in the deceleration process. The output end 20 runs at a high speed, and a speed in the high-speed gear state is higher than a speed in the low-speed gear state.

Furthermore, the shift assembly 5 is connected to the inner ring gear 31 of the planetary gear reduction mechanism. When the user moves the shift assembly 5, the inner ring gear 31 can be driven to move, thereby switching between the first state and the second state.

Please referring to FIG. 1 and FIG. 2, the housing 1 includes a body 11 receiving the motor assembly 2 and the transmission assembly 3, a handle 12 connected to the body 11, and a joint 13 arranged on an end of the handle 12. The body 11 and the joint 13 are arranged on an upper side and a lower side of the handle 12, respectively, i.e. the handle 12 is arranged at the body and the joint 13 is arranged on an end of the handle 12 away from the body. Furthermore, the handle 12 and the body 11 are arranged at an angle to provide a more comfortable grip for the user, in accordance with ergonomics. That is, the angle is greater than 0 degrees and less than 120 degrees. The switch assembly 4 is arranged on an upper end of the handle 12 near the body 11. The user can grip the handle 12 with an entire palm and press the switch assembly 4 with a single index or a middle finger, making the operation more comfortable and convenient.

In the embodiments, the battery pack 200 is detachably arranged at the joint 13, and the motor assembly 2 has a first axis Al extending along a front to back direction as shown in FIG. 1 and FIG. 2. An insertion direction of the battery pack 200 is roughly the same as an extension direction of the first axis A1. This arrangement allows the electric drill 100 to be stably placed on a working surface with the battery pack 200 as a support.

In some embodiments, a nominal voltage of the battery pack 200 can be greater than or equal to 10V and less than or equal to 20V. For example, the nominal voltage of the battery pack 200 can be 12V, 18V, 20V, etc. In some embodiments, the nominal voltage of the battery pack 200 can be greater than or equal to 20V and less than or equal to 100V. For example, the nominal voltage of the battery pack 200 can be 24V, 40V, 56V, 80V, etc.

In some embodiments, the number of battery cells included in a cell unit group in the battery pack 200 can be greater than or equal to 3 and less than or equal to 5, for example, the number of the battery cells included in the cell unit group can be 3, 4, or 5. In some embodiments, the number of the battery cells included in the cell unit group in the battery pack 200 can be greater than or equal to 6 and less than or equal to 25. For example, the number of the battery cells included in the cell unit group can be 6, 10, 14, 20, etc.

In the embodiments, the switch assembly 4 includes a switch component 41 arranged at the housing 1 and a trigger 42 for triggering the switch component 41. Furthermore, the switch assembly 4 is a speed control switch and adjusts an output speed of the motor assembly 2 through a pressing stoke of the trigger 42, and the output speed of the motor assembly 2 is approximately proportional to the pressing stoke of the trigger 42. Specifically, the motor assembly 2 operates at a maximum output speed in response to the user pressing the trigger 42 to a full pressing stoke (i.e., to a maximum extent); the motor assembly 2 operates at a half of the maximum output speed in response to the user pressing trigger 42 halfway through the pressing stoke.

The switch assembly 4 is well-known. Specifically, the switch assembly 4 can be a stepless speed control switch. Furthermore, the above switch assembly 4 is a DC speed control switch and is used to adjusts the output speed of the motor assembly 2 in the handheld power tool.

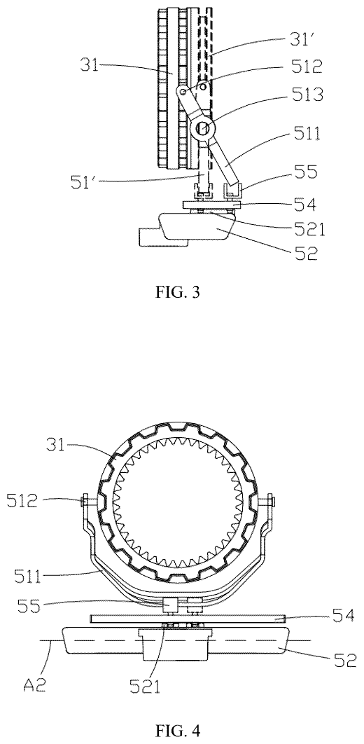

Please referring to FIG. 3 to FIG. 7, the shift assembly 5 includes a shift component 51 connected to the inner ring gear 31 of the transmission assembly 3, a button 52 for moving the shift component 51, a stop portion 53 connected to the button 52, an intermediate plate 54 fixed to the housing 1, and a guide 55 connected between the shift component 51 and the button 52. The button 52 includes a first position corresponding to the first state and a second position corresponding to the second state. That is, the button 52 can move back and forth between the first and second positions. When moved to the first position, the button 52 is in the first state, and when moved to the second position, the button 52 is in the second state. The user can switch between the first state and the second state by moving the button 52.

FIG. 3 shows a schematic view of the shift component 51 (51′) and the inner ring gear 31 (31′) at the different positions in two states.

In the embodiments, please continuously referring to FIG. 1, and FIG. 4, the button 52 is arranged between the transmission assembly 3 and the switch assembly 4. The button 52 extends along a direction of a second axis A2 approximately perpendicular to the first axis A1, and both ends of the button 52 protrude to an outside of the housing 1 for the user to press and operate. Thus, while grasping the handle 12, the user uses a thumb and an index finger to abut against both ends of the button 52, such that the button 52 is able to be pushed back and forth along the direction of the second axis A2 to quickly switch between the first and second positions. Therefore, gear shifting can be completed with one hand, with simple operation and good user experience. In addition, setting the button 52 between the transmission assembly 3 and the switch assembly 4 can reduce height occupied by the body 11 in an up-down direction, allowing the electric drill 100 to be used normally in a narrow space and improving the performance of the electric drill 100 during edge bonding operations.

In the embodiments, the control assembly 6 is arranged inside the handle 12 and arranged on a lower side of the switch assembly 4. The control assembly 6 and the button 52 are respectively arranged on the lower side and the upper side of the switch assembly 4, i.e., the button 52 is arranged on the upper side of the switch assembly 4, and the control assembly 6 is arrange on the lower side of the switch assembly 4. This arrangement makes component layout of the drill 100 more reasonable.

In some embodiments, the control assembly 6 is arranged inside the body 11 and is arranged on a rear side of the motor assembly 2.

In some embodiments, the shift component 51 extends along a circumference of the inner ring gear 31 and includes a U-shaped connecting portion 511, a pair of connecting arms 512 respectively arranged on both ends of the connecting portion 511 in one-to-one correspondence, and a pivot portion 513 arranged between the connecting portion 511 and the connecting arm 512. The pair of connecting arms 512 are respectively connected to both sides of the inner ring gear 31 in one-to-one correspondence, and the pivot portion 513 is arranged at the housing 1. The button 52 moves in the direction of the second axis A2, driving the shift component 51 to rotate around the pivot portion 513 and driving the inner ring gear 31 to move along the direction of the first axis A1, thereby achieving free switching between two gears.

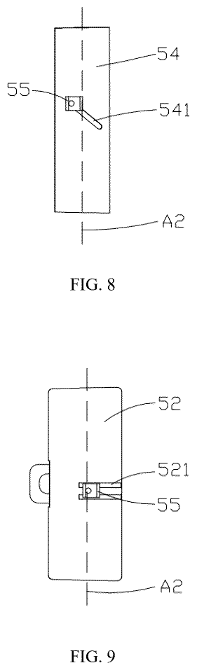

Please referring to FIG. 8, the intermediate plate 54 is arranged between the shift component 51 and the button 52. The intermediate plate 54 extends along the direction of the second axis A2 and is approximately parallel to the button 52. The intermediate plate 54 defines a guide groove 541 which is a through groove, and the guide 55 moves within the guide groove 541. The intermediate plate 54 is fixed and does not move, and the guide groove 541 serves as a guide for movement of the guide 55.

Furthermore, the second axis A2 is approximately perpendicular to the first axis A1. In order to convert the movement of the button 52 along the second axis A2 into the movement of the inner ring gear 31 along the first axis A1, the extension direction of the guide groove 541 and the second axis A2 are arranged at an angle, and the angle is greater than 0 degrees and less than 180 degrees.

As shown in FIG. 9, the button 52 includes a pair of convex ribs 521 extending from an end face of the button 52 towards the intermediate plate 54. Extension directions of the pair of convex ribs 521 are approximately parallel to each other and approximately perpendicular to the second axis A2. The guide 55 is arranged between the pair of convex ribs 521, and abuts against the convex rib 521 and slides along a side wall of the pair of convex ribs 521.

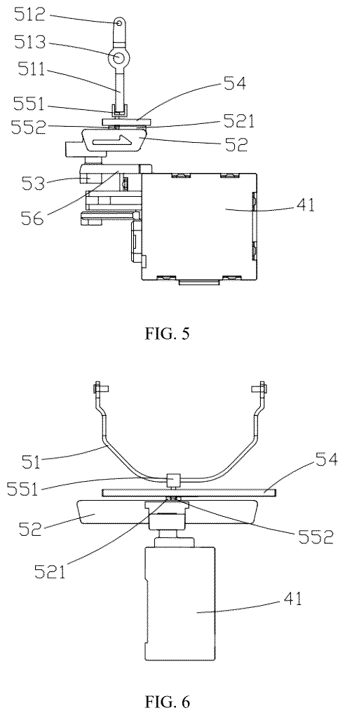

In the embodiments, please referring to FIG. 6 together, the guide 55 includes a pawl 551 connected to the shift component 51 and a guide column 552 extending downward from a bottom of the pawl 551. The guide column 552 extends through the guide groove 541 and abuts against the convex rib 521. Furthermore, the claw 551 is arranged in a U-shape, and at least a part of the connecting portion 511 of the shift component 51 is arranged inside the claw 551.

In the embodiments, the claw 551 and the guide column 552 are integrally formed.

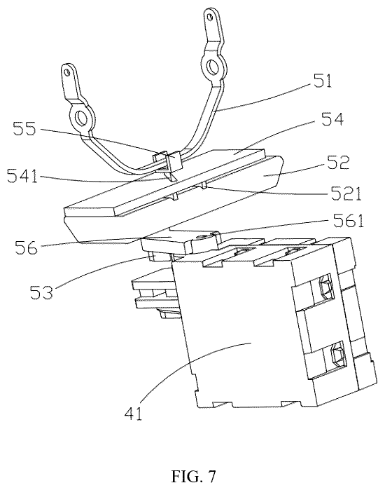

Please referring to FIG. 5 and FIG. 7, the stop portion 53 is connected to a lower side of the button 52 and moves with movement of the button 52. In some embodiments, the stop portion 53 is connected to a side of the button 52 away from the intermediate plate 54. The stop portion 53 is arranged between the button 52 and the trigger 42.

Furthermore, the stop portion 53 protrudes downward from a lower end of the button 52, and the stop portion 53 and the button 52 are integrally formed.

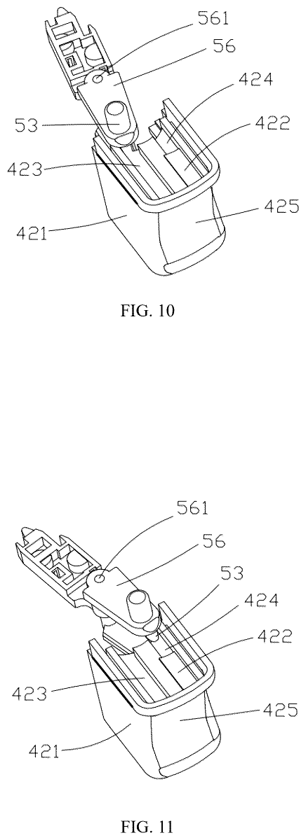

Please referring to FIG. 5, FIG. 10 and FIG. 11 together, the shift assembly 5 also includes an adjustment plate 56 connected to the button 52, and the adjustment plate 56 protrudes from the stop portion 53 towards the switch component 41. The adjustment plate 56 has a pivot 561 connected to the switch component 41. When the user moves the button 52, the adjustment plate 56 is driven to rotate around the pivot 561. During the rotation of the adjustment plate 56, different signals are generated to the switch component 41, and the different signals can be used to achieve functions such as forward and reverse rotation switching of the motor assembly 2.

Furthermore, a spring clip can be arranged at the connection position between the pivot 561 of the adjustment plate 56 and the switch component 41 to provide a better operating feel for the user when moving the button 52.

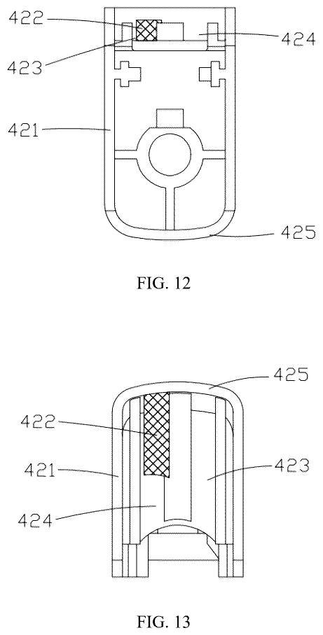

Please referring to FIG. 10 to FIG. 13, the trigger 42 includes a base 421, a limiting portion 422 arranged at the base 421, and a pressing portion 425 for the user to press. The pressing portion 425 and the limiting portion 422 are respectively arranged on different end faces of the base 421. Specifically, the pressing portion 425 is arranged on a side of the base 421 away from the switch component 41, and the limiting portion 422 is arranged on another end face of the base 421, that is, the limiting portion 422 is arranged on the upper side of the base 421. In some embodiments, the limiting portion 422 is arranged on a side of the base 421 facing to the shift assembly 5. The limiting portion 422 is adjacent to the stop portion 53, and the stop portion 53 is arranged on a path of the pressing stoke of the trigger 42, therefore during the pressing process of the trigger 42, the limiting portion 422 abuts against the stop portion 53, restricting the trigger 42 from being pressed to the full pressing stoke (i.e. from being pressed to a maximum extent). Therefore, the maximum output speed of the motor assembly 2 is limited. In actual use, the output end 20 can output the force required by the user at a lower speed to meet the needs of different working scenarios.

In the embodiments, the stop portion 53 is arranged between the button 52 and the base 421, and at least a part of the stop portion 53 is arranged between the trigger 42 and the switch component 41.

In the embodiments, an end face of the base 421 facing the stop portion 53 is provided with a slideway, that is, the slideway is arranged on the upper side of the base 421, and the stop portion 53 moves within the slideway. The limiting portion 422 is arranged inside the slideway, restricting the trigger 42 from being pressed to the full pressing stoke (i.e. from being pressed to a maximum extent) to limit the maximum output speed of the motor assembly 2.

Specifically, the slideway includes a first slideway 423 corresponding to the first position and a second slideway 424 corresponding to the second position, and the limiting portion 422 is arranged on at least one of the first slideway 423 and the second slideway 424. In the first state, the stop portion 53 moves within the first slideway 423. In the second state, the stop portion 53 moves within the second slideway 424.

Furthermore, the limiting portion 422 is arranged at the second slideway 424. Since the first state is the low-speed gear state and the second state is the high-speed gear state, the first state corresponds to the first position and the first slideway 423 and the second state corresponds to the second position and the second slideway 424. Based on a theoretical model of planetary gears, a reduction ratio of each stage is 1+Z3/Z1, where Z3 is the number of teeth of the inner ring gear and Z1 is the number of teeth of a sun gear. The reduction ratio of each stage of planetary gears is not less than 3. If the ratio of the speed in the high-speed gear state to the speed in the low-speed gear state is less than 3, traditional planetary gear reducers are basically unable to achieve it.

In the embodiments, by setting the limiting portion 422 inside the second slideway 424, the user presses the trigger 42 in the high-speed gear state, and the limiting portion 422 abuts against the stop portion 53, restricting the trigger 42 from being pressed to the full pressing stoke (i.e. from being pressed to a maximum extent). Therefore, the maximum output speed of the motor assembly 2 is limited, and even in the high-speed gear state, the user can obtain a force with the lower speed, breaking through the limitation that traditional planetary gear reducers cannot achieve a speed ratio of less than 3 between the high-speed gear state and the low-speed gear state, effectively meeting the diverse work needs of users.

In the embodiments, the speed ratio of the speed in the high-speed gear state to the speed in the low-speed gear state is less than 3.

In the embodiments, the limiting portion 422 is arranged inside the second slideway 424, so a length of the second slideway 424 is smaller than a length of the first slideway 423, and the length settings of the first slideway 423 and the second slideway 424 can be adaptively adjusted based on the actual requirements of the output speed.

The present disclosure is not limited to the specific embodiments mentioned above. Those of ordinary skill in the art can easily understand that, without departing from the principles and scope of the present disclosure, there are many other alternative solutions for the handheld power tool of the present disclosure. The scope of protection of the present disclosure is subject to the content of the claims.

1. A handheld power tool, comprising:
a housing, comprising a body and a handle connected to the body;
a motor assembly and a transmission assembly both received in the body, wherein the motor assembly has a first axis extending along a front to back direction;
a switch assembly connected to the motor assembly and arranged at the handle, and the switch assembly comprising a switch component arrange at the housing and a trigger for triggering the switch component, and the trigger comprising a base and a limiting portion arranged at the base; and
a shift assembly connected to the transmission assembly, the shift assembly comprising a shift component connected to the transmission assembly, a button for moving the shift component, and a stop portion corresponding to the limiting portion, wherein the limiting portion abuts against the stop portion, restricting the trigger from being pressed to a maximum extent, the button moves along a direction of a second axis approximately perpendicular to the first axis, and the button is arranged between the transmission assembly and the switch assembly.

2. The handheld power tool as claimed in claim 1, wherein the stop portion is connected to the button and arranged between the button and the trigger.

3. The handheld power tool as claimed in claim 1, wherein the switch assembly is a speed control switch and adjusts an output speed of the motor assembly through a pressing stoke of the trigger, and the limiting portion abuts against the stop portion to limit a maximum output speed of the motor assembly.

4. The handheld power tool as claimed in claim 1, wherein the handheld power tool comprises a control assembly for controlling the motor assembly, and the switch assembly is electrically connected to the control assembly.

5. The handheld power tool as claimed in claim 4, wherein the control assembly is arranged at the handle, and the control assembly is arranged on a side of the switch assembly and the button is arranged on another side of the switch assembly.

6. The handheld power tool as claimed in claim 4, wherein the control assembly is arranged at the body, and arranged on a rear side of the motor assembly.

7. The handheld power tool as claimed in claim 1, wherein the handle and the body portion are arranged at an angle, and the housing comprises a joint arranged on an end of the handle, a battery pack for supplying energy to the motor assembly is detachably arranged at the joint.

8. The handheld power tool as claimed in claim 1, wherein the stop portion is arranged between the button and the base.

9. The handheld power tool as claimed in claim 8, wherein at least a part of the stop portion is arranged between the trigger and the switch component.

10. The handheld power tool as claimed in claim 1, wherein the transmission assembly is a planetary gear reduction mechanism, the handheld power tool comprises an output end driven by the transmission assembly; the output end is configured to work in a first state and a second state that operate at different speeds, a speed in the second state is higher than a speed in the first state, and a ratio of the speed in the second state to the speed in the first state is less than 3.

11. The handheld power tool as claimed in claim 10, wherein the planetary gear reduction mechanism has an inner ring gear having an ability of being moved, the button is configured to drive the inner ring gear to move, thereby switching between the first state and the second state.

12. The handheld power tool as claimed in claim 11, wherein both ends of the button protrude to an outside of the housing such that the button is able to be pushed back and forth along the direction of the second axis.

13. The handheld power tool as claimed in claim 10, wherein an end face of the base facing the stop portion is provided with a first slideway and a second slideway, the first slideway corresponds to the first state, the second slideway corresponds to the second state, and the limiting portion is arranged on at least one of the first slideway and the second slideway; in the first state, the stop portion moves within the first slideway, and in the second state, the stop portion moves within the second slideway.

14. A handheld power tool, comprising:
a housing, comprising a body and a handle connected to the body, wherein the handle and the body are arranged at an angle;
a motor assembly and a transmission assembly, both received in the body, wherein the motor assembly has a first axis extending along a front to back direction, and the transmission assembly is a planetary gear reduction mechanism;
an output end, driven by the transmission assembly, and the output end is configured to work in a first state and a second state that operate at different speeds;
a switch assembly, connected to the motor assembly and arranged at the handle; and
a shift assembly, connected to the transmission assembly, the shift assembly comprising a shift component connected to the transmission assembly, and a button for moving the shift component;
wherein the button moves along a direction of a second axis approximately perpendicular to the first axis and is configured to switch between the first state and the second state, a speed in the second state is higher than a speed in the first state, and a ratio of the speed in the second state to the speed in the first state is less than 3.

15. The handheld power tool as claimed in claim 14, wherein the switch assembly is arranged on an end of the handle near the body, the button is arranged between the transmission assembly and the switch assembly.

16. The handheld power tool as claimed in claim 14, wherein the switch assembly comprising a switch component arrange at the housing and a trigger for triggering the switch component, the trigger comprising a base and a limiting portion arranged at the base, the shift assembly comprising a stop portion corresponding to the limiting portion, wherein the limiting portion abuts against the stop portion, restricting the trigger from being pressed to a maximum extent.

17. The handheld power tool as claimed in claim 16, wherein the stop portion is connected to the button and arranged between the button and the trigger.

18. The handheld power tool as claimed in claim 16, wherein the switch assembly is a speed control switch and adjusts an output speed of the motor assembly through a pressing stoke of the trigger, and the limiting portion abuts against the stop portion to limit a maximum output speed of the motor assembly.

19. A handheld power tool, comprising:
a housing, comprising a body and a handle connected to the body;
a motor assembly and a transmission assembly, both received in the body, wherein the motor assembly has a first axis extending along a front to back direction;
a switch assembly, connected to the motor assembly and arranged at the handle; and
a shift assembly, connected to the transmission assembly, and the shift assembly comprising a shift component connected to the transmission assembly and a button for moving the shift component, wherein the button moves along a direction of a second axis approximately perpendicular to the first axis, and the button is arranged between the transmission assembly and the switch assembly.

20. The handheld power tool as claimed in claim 19, wherein the switch assembly comprises a switch component arrange at the housing and a trigger for triggering the switch component, and the trigger comprises a base and a limiting portion arranged at the base; the shift assembly further comprises a stop portion corresponding to the limiting portion, the limiting portion abuts against the stop portion, restricting the trigger from being pressed to a maximum extent, and at least a part of the stop portion is arranged between the trigger and the switch component.
